(19) United States
(12) Patent Application Publication
(10) Pub. No.: US 2016/0163210 A1
(43) Pub. Date: Jun. 9, 2016

(54) Automated Framework For Personalized Learning From Heterogeneous Data Repositories

(71) Applicant: The Trustees of The Stevens Institute of Technolog, Hoboken, NJ (US)

(72) Inventor: Theodoros Lappas, New York, NY (US)

(21) Appl. No.: 14/559,397

(22) Filed: Dec. 3, 2014

(51) Int. Cl. G09B 5/06; G06F 17/30

(52) U.S. Cl. CPC G09B 5/06; G06F 17/30525; G06F 17/30725; G06F 17/30702

(57) ABSTRACT

An automated framework for personalized learning from heterogeneous data repositories is presented. The framework leverages learning modules that are extracted by harvesting and annotating material from online and offline sources. The composed library of modules is then used as a basis for creating and delivering a personalized learning plan to a user who is interested in covering specific learning objectives. The framework introduces a new paradigm to the e-learning space by addressing the automatic collection and annotation of learning modules, the direct mapping of modules to learning objectives, and the continuous improvement of the entire framework by utilizing the feedback collected from the user's interaction with the delivered material.

### CROSS REFERENCE TO RELATED APPLICATION

This application claims the benefit of U.S. Provisional Application No. 61/911,625, filed Dec. 4, 2013, which is incorporated by reference herein in its entirety.

### FIELD OF THE INVENTION

The invention relates to education and digital learning and, more particularly, to personalized learning educational software.

### BACKGROUND OF THE INVENTION

Personalized educational software is used to provide a targeted learning experience to a user. Generally, however, educational software of this type requires a store of already available and fully annotated educational material from which it can create a targeted learning experience. This is necessarily limiting as new educational material is created daily. Further, it would be costly and time consuming to continually search, identify and annotate educational material, as well as costly and time consuming to continually update the educational software to include such material. Thus, it is desired to provide educational software capable of automatically identifying, retrieving, and annotating material from heterogeneous or external sources.

### SUMMARY OF THE INVENTION

In an embodiment, a detailed, end-to-end framework solution for a user who wants to cover a specific set of learning objectives by optimally utilizing educational material present in heterogeneous sources. A given framework can utilize any type of educational material, including textual data (e.g., books and research papers), video and audio files, online and offline tutorials and courses, exercise problem sets, and simulations. In an embodiment, the framework includes three primary components: 1) collection and annotation of educational data, 2) personalized content delivery and collection of feedback, and 3) feedback analysis and improvement.

In another embodiment, a method for automatically developing and presenting educational content to a user, includes accessing a data collection having heterogeneous data in digital form; processing the data by annotating the data, producing annotations; identifying a set of topical objectives and expressing the topical objectives in digital form; automatically mapping the annotations to the topical objectives; identifying learning objectives for a person; automatically matching selected ones of the topical objectives to the learning objectives of the person to form at least one learning module; presenting the at least one learning module to the person.

In another embodiment, the steps of accessing, processing and mapping are periodically automatically repeated to harvest new data that has been added to the data collection after a previous iteration.

In another embodiment, the step of processing is automatic via at least one of algorithms for text mining or natural language processing.

In another embodiment, meta-data is mined and used for annotating.

In another embodiment, the heterogeneous data includes at least one of a textbook, a video, a research paper, an audio clip, an exercise or an online tutorial.

In another embodiment, the annotations are at least initially constructed manually, as is a set of tags attached to each topical objective.

In another embodiment, the learning modules are continuously enriched with automatically generated tags mined from textual sources that describe content, the attached set of tags being compared against that of each available learning module, each of the matching tags being then directly mapped to the matching learning module.

In another embodiment, the step of identifying learning objectives for the person includes collecting data on the person including at least one of the person's educational background, professional background, age or demographics and concepts that the person desires to learn.

In another embodiment, the learning modules presented during the step of presenting include a personalized learning plan for the person.

In another embodiment, the learning objectives are identified by automatically evaluating the user's personal profile data and using the profile data as criteria for selecting a subset of the data for the person.

In another embodiment, the learning objectives are at least initially identified manually by an expert.

In another embodiment, further including the step of receiving feedback from the person based upon the person's interaction with the at least one learning module.

In another embodiment, feedback from a plurality of persons is used to evaluate and edit the at least one learning module.

In another embodiment, the feedback is at least one of voting, tagging or commenting.

In another embodiment, further including the step of evaluating a level of the person's assimilation of the learning module presented to the person

In another embodiment, further including the step of seeking supplementary data on for the learning module in the event that the person's assimilation level is deficient.

In another embodiment, a computer system implements the steps of the method described above.

In another embodiment, digital storage media has program code thereon that implements the method described above.

### DETAILED DESCRIPTION OF THE INVENTION

In an embodiment, the framework comprises three primary components (a data collection and annotation component, a personalized delivery component, and a feedback and improvement component), where each component may include clearly defined sub-components. A detailed description of educational software architecture according to an embodiment of the present invention is described below.

With reference to the data collection and annotation component, inputs to the component include large volumes of heterogeneous data (e.g., digital textbooks, articles, websites, videos, research and technical papers, audio files, tutorials, exercises, simulations) from all available repositories. The data could come from the World Wide Web (i.e., open access data) or from an accessible set of pre-identified sources.

In an embodiment, the component has an output which includes a library of annotated educational modules, where each module is mapped to the set of objectives (i.e., topics) that it can be used to cover.

In an embodiment, processing (“Phase 1”) in the data collection and annotation component can be executed in a first, second and third phase. In the first phase (“Phase 1.1”), data is retrieved from all available repositories. This process may be automated. For each new repository that is made available, a new interface is implemented that allows the automatic and periodic harvesting of new material.

In an embodiment, in the second phase (“Phase 1.2”), the material harvested in Phase 1.1 is identified, extracted, and annotated so as to form learning modules. This process may be automated. The modules may be any cohesive unit that can be used in the learning process (e.g., a textbook or part of a textbook, a video or audio clip, an exercise, an online tutorial). Annotation of each module depends on its type. For instance, textual data is annotated (e.g., tagged) via algorithms for text mining and natural language processing. When available, meta-data (e.g., comments or ratings on a video clip) may also be mined and used in the annotation process.

In an embodiment, the third phase (“Phase 1.3”) maps each annotated module produced during Phase 1.2 to concepts (e.g., learning objectives to be achieved, topics to be learned, skills to be acquired) that are covered by the module. For example, a research paper on healthy dietary habits could be mapped to the concepts “nutrition” and “health”, among others. Mapping is achieved through use of an information network that connects each concept to relevant annotations (i.e., tags).

In an embodiment, a set of considered concepts is constructed and maintained manually, as is a set of tags attached to each concept. The latter is continuously enriched with automatically generated tags, mined from textual sources that describe the content (e.g. a Wikipedia page, relevant articles, research papers). When a new concept is introduced, the attached set of tags is compared against that of each available module. Each of the matching modules is then directly mapped to the concept.

Referring now to the personalized delivery component, an embodiment of the invention has inputs including: a library of annotated modules constructed and maintained in Phase 1; a user's profile including educational and professional background, age, demographics, and other relevant information; and concepts that the user desires to learn (e.g., a set of skills to be acquired or topics to be covered).

In an embodiment, the outputs of the personalized delivery component include a personalized learning plan for the user and feedback on the user's interaction with each learning module.

In an embodiment, processing (“Phase 2”) in the personalized delivery component is executed in a first and second phase. Initially, in the first phase (“Phase 2.1”), the set of relevant (i.e., mapped) modules is retrieved for each target concept specified by the user. Then, by taking into consideration the user's personal profile, an appropriate subset of these modules is selected and included in the user's personalized learning plan. In the early stages of deployment, the selection process can be completed manually by an expert (e.g., an instructor) or in an automated and randomized manner. The latter is optimized by testing on a body of test users in order to collect feedback on the fitness of each module for different learner profiles. The selection process may then be gradually automated as more data is accumulated, until all manual intervention is phased out (see Phase 3 below).

In an embodiment, in the second phase (“Phase 2.2”), the set of learning modules selected in Phase 2.1 is delivered to the user via an interactive platform that monitors and records the user's interaction with each module. Users can vote, tag, and comment, among other things, on each module. If assessment modules are available and applicable, the user's performance may also be recorded in the context of target concept(s) mapped to the module. The collection of feedback is organized and delivered to Phase 3 for further analysis as described below.

Referring now to the feedback and improvement component, an embodiment of the invention has inputs which include: feedback on the user's interaction with each learning module; the user's profile including educational and professional background, age, demographics, and other relevant information; and concepts that the user desires to learn (e.g., a set of skills to be acquired or topics to be covered).

In an embodiment, the outputs of this component include updated coverage scores for any concept-module-profile triplets.

In an embodiment, the feedback collected from Phase 2.2 is analyzed to evaluate the success or failure of each module in covering different target concepts for a particular user profile. The accumulation of such knowledge is used to support and automate the process of selecting a set of modules that is delivered to each user (see Phase 2.1) based on their profile and target concepts. The decision may be based on the previous success of modules for these concepts when delivered to users with similar profiles. This process of continuous evaluation enables automatic and prompt identification of gaps in an available library of modules. Further, as feedback is collected and analyzed, the system identifies concepts that cannot be successfully covered by any of the available modules in the library, in the context of particular user profiles. The identification of such gaps is used to inform Phase 1.1 that a new source of educational material should be added to the set of monitored repositories.

It should be understood that the embodiments described herein are merely exemplary in nature and that a person skilled in the art may make many variations and modifications thereto without departing from the scope of the present disclosure and claims. All such variations and modifications, including those discussed above, are intended to be included within the scope of the claims.

We claim:

1. A method for automatically developing and presenting educational content to a user, comprises:
accessing a data collection having heterogeneous data in digital form;
processing the data by annotating the data, producing annotations;
identifying a set of topical objectives and expressing the topical objectives in digital form;
automatically mapping the annotations to the topical objectives;
identifying learning objectives for a person;
automatically matching selected ones of the topical objectives to the learning objectives of the person to form at least one learning module;
presenting the at least one learning module to the person.

2. The method of claim 1, wherein the steps of accessing, processing and mapping are periodically automatically repeated to harvest new data that has been added to the data collection after a previous iteration.

3. The method of claim 1, wherein the step of processing is automatic via at least one of algorithms for text mining or natural language processing.

4. The method of claim 3, wherein meta-data is mined and used for annotating.

5. The method of claim 1, wherein the heterogeneous data includes at least one of a textbook, a video, a research paper, an audio clip, an exercise or an online tutorial.

6. The method of claim 1, wherein the annotations are at least initially constructed manually, as is a set of tags attached to each topical objective.

7. The method of claim 6, wherein the learning modules are continuously enriched with automatically generated tags mined from textual sources that describe content, the attached set of tags being compared against that of each available learning module, each of the matching tags being then directly mapped to the matching learning module.

8. The method of claim 1, wherein the step of identifying learning objectives for the person includes collecting data on the person including at least one of the person's educational background, professional background, age or demographics and concepts that the person desires to learn.

9. The method of claim 1, wherein the learning modules presented during the step of presenting include a personalized learning plan for the person.

10. The method of claim 1, wherein the learning objectives are identified by automatically evaluating the user's personal profile data and using the profile data as criteria for selecting a subset of the data for the person.

11. The method of claim 1, wherein the learning objectives are at least initially identified manually by an expert.

12. The method of claim 1, further comprising the step of receiving feedback from the person based upon the person's interaction with the at least one learning module.

13. The method of claim 12, wherein feedback from a plurality of persons is used to evaluate and edit the at least one learning module.

14. The method of claim 13, wherein the feedback is at least one of voting, tagging or commenting.

15. The method of claim 1, further comprising the step of evaluating a level of the person's assimilation of the learning module presented to the person

16. The method of claim 15, further comprising the step of seeking supplementary data on for the learning module in the event that the person's assimilation level is deficient.

17. A computer system that implements the method of claim 1.

18. A digital storage media having a program code thereon that implements the method of claim 1.
